(19) United States
(12) Patent Application Publication
(10) Pub. No.: US 2024/0405465 A1
(43) Pub. Date: Dec. 5, 2024

(54) CONNECTION TERMINAL

(71) Applicant: YAZAKI CORPORATION, Tokyo (JP)

(72) Inventors: Satoshi Nakai, Makinohara-shi (JP); Tomohiro Hikosaka, Makinohara-shi (JP); Masaaki Iwabe, Makinohara-shi (JP)

(21) Appl. No.: 18/663,036

(22) Filed: May 13, 2024

(30) Foreign Application Priority Data
May 29, 2023 (JP) 2023-087380

(51) Int. Cl. H01R 13/11

(52) U.S. Cl. CPC H01R 13/111

(57) ABSTRACT

A connection terminal includes: a male terminal including a male-side contact portion formed in a cylindrical shape; and a female terminal including a female-side contact portion formed in a cylindrical shape and having a linear slit formed in an axial direction. The female terminal has an insertion space formed inside the female-side contact portion and into which the male-side contact portion is inserted, and a base portion at a position facing the slit across the insertion space. In the connection terminal, the female-side contact portion is bent outward in a radial direction intersecting the axial direction with the base portion as a bending starting point and applies a contact load to the male-side contact portion in an insertion state in which the male-side contact portion is inserted into the insertion space.

### CROSS-REFERENCE TO RELATED APPLICATION(S)

The present application claims priority to and incorporates by reference the entire contents of Japanese Patent Application No. 2023-087380 filed in Japan on May 29, 2023.

### BACKGROUND OF THE INVENTION

### 1. Field of the Invention

The present invention relates to a connection terminal.

### 2. Description of the Related Art

In a connection terminal according to the related art, for example, in order to stably obtain a contact area between contacts of a male terminal, which is a so-called pin terminal, and a female terminal, the female terminal includes a spring contact member in which a plurality of spring pieces that come into contact with a circumferential surface of the inserted pin terminal with an elastic force are arranged in parallel with a gap therebetween and are held in such a way as to form a tubular shape in a terminal body (see, for example, Japanese Patent Application Laid-open No. 2013-187170 A).

In the connection terminal according to the related art described above, the female terminal includes a plurality of components, and thus, there is room for improvement in terms of reducing component costs and component assembly workload and achieving precise positioning between the components.

### SUMMARY OF THE INVENTION

An object of the present invention is to provide a connection terminal capable of reducing the number of components.

In order to achieve the above mentioned object, a connection terminal according to one aspect of the present invention includes a male terminal including a male-side contact portion formed in a cylindrical shape; and a female terminal including a female-side contact portion formed in a cylindrical shape and having a linear slit formed in an axial direction, wherein the female terminal has an insertion space formed inside the female-side contact portion and into which the male-side contact portion is inserted, and a base portion located at a position facing the slit across the insertion space, and the female-side contact portion is bent outward in a radial direction intersecting the axial direction with the base portion as a bending starting point and applies a contact load to the male-side contact portion in an insertion state in which the male-side contact portion is inserted into the insertion space.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a connection terminal according to a first embodiment;

FIG. 2 is a view of a female terminal of FIG. 1 when viewed from a second axial direction side;

FIG. 3 is a perspective view illustrating a schematic configuration of a connection terminal according to a second embodiment;

FIG. 4 is a view of a female terminal of FIG. 3 when viewed from a second axial direction side;

FIG. 5 is another view of the female terminal of FIG. 3 when viewed from the second axial direction side;

FIG. 6 is a cross-sectional view illustrating a schematic configuration of the connection terminal according to the second embodiment;

FIG. 7 is a perspective view illustrating a schematic configuration of a connection terminal according to a third embodiment;

FIG. 8 is a view of a female terminal of FIG. 7 when viewed from a second axial direction side;

FIG. 9 is a perspective view illustrating a schematic configuration of a connection terminal according to a modified example of the third embodiment;

FIG. 10 is a view of a female terminal in FIG. 9 when viewed from a second axial direction side; and

FIG. 11 is a cross-sectional view illustrating a schematic configuration of the connection terminal according to the modified example of the third embodiment.

### DETAILED DESCRIPTION OF THE PREFERRED EMBODIMENTS

Hereinafter, embodiments according to the present invention will be described in detail with reference to the drawings. Note that the present invention is not limited by the embodiments. That is, constituent elements in the following embodiments include those that can be easily assumed by those skilled in the art or those that are substantially the same, and various omissions, substitutions, and changes can be made without departing from the gist of the invention.

### First Embodiment

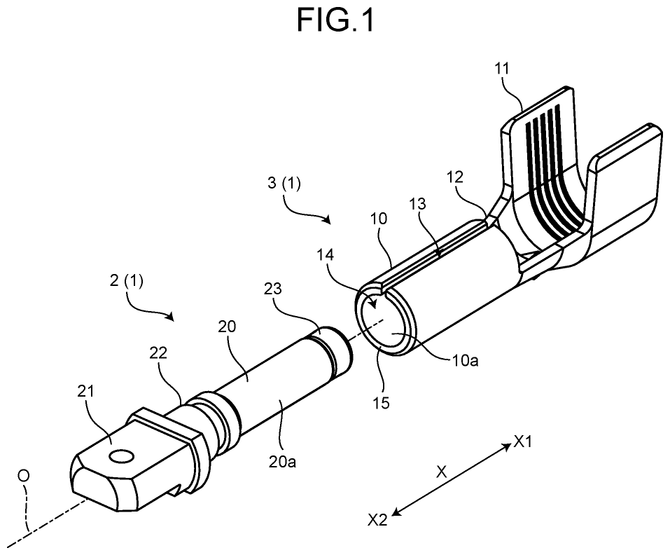

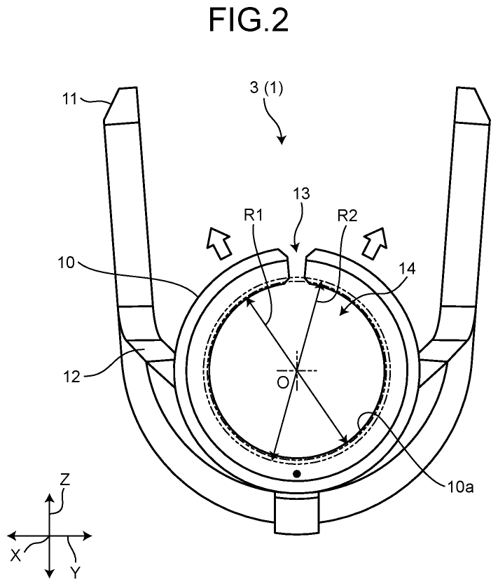

First, a connection terminal 1 according to a first embodiment will be described with reference to FIGS. 1 and 2. The connection terminal 1 illustrated in FIG. 1 includes a male terminal 2 and a female terminal 3, and electrically connects the male terminal 2 and the female terminal 3 by fitting the male terminal 2 into the female terminal 3.

In the following description, for convenience, among an X direction, a Y direction, and a Z direction in the drawings, the X direction is referred to as an “axial direction X”, the Y direction is referred to as a “width direction Y”, and the Z direction is referred to as a “height direction Z”. The axial direction X, the width direction Y, and the height direction Z are orthogonal to each other. The axial direction X corresponds to a direction along a central axis O. The width direction Y and the height direction Z are included in directions orthogonal to the axial direction X. The axial direction X is an insertion and removal direction of the male terminal 2 with respect to the female terminal 3, and the insertion direction is a “first axial direction X1” and the removal direction is a “second axial direction X2”.

The connection terminal 1 is mounted on a vehicle such as an automobile, for example, and is applied to a connector incorporated in a wire harness, an electrical connection box, an electronic component, and the like. Here, for example, the wire harness is configured in such a way that a plurality of electric wires used for power supply and signal communication are bundled to form an assembly component for connection between devices mounted on a vehicle, and the plurality of electric wires are connected to the devices by a connector or the like.

The male terminal 2 includes a male-side contact portion 20, a connector connection portion 21, a coupling portion 22, and a cap 23. In the male terminal 2, the male-side contact portion 20, the connector connection portion 21, and the coupling portion 22 excluding the cap 23 are integrally formed of a conductive metal material, for example, copper, a copper alloy, aluminum, an aluminum alloy, or the like. The cap 23 is formed separately from the male-side contact portion 20, the connector connection portion 21, and the coupling portion 22, and is molded from an insulating resin material or the like. In the male terminal 2, the cap 23, the male-side contact portion 20, the coupling portion 22, and the connector connection portion 21 are arranged in this order from the first axial direction X1 toward the second axial direction X2 along the axial direction X and are coupled to each other.

The male-side contact portion 20 is a portion where an outer circumferential surface 20a of the male-side contact portion 20 comes into contact with and is electrically connected to the female terminal 3, which is a mating terminal, in a fitted state in which the male terminal 2 is fitted to the female terminal 3. The male-side contact portion 20 is formed in a cylindrical shape in which the central axis O is along the axial direction X. The cap 23 is mounted on a first axial direction X1 side of the male-side contact portion 20, and the connector connection portion 21 is coupled to a second axial direction X2 side of the male-side contact portion 20 via the coupling portion 22.

The connector connection portion 21 is, for example, a portion that is connected to a connector, an electric wire housed in an electrical connection box, an electronic component, or the like, and is electrically connected thereto.

The coupling portion 22 is a portion that is interposed between the male-side contact portion 20 and the connector connection portion 21 and couples the male-side contact portion 20 and the connector connection portion 21. An outer diameter of the coupling portion 22 is relatively larger than an outer diameter of the male-side contact portion 20, and the coupling portion 22 abuts on an end portion of the female terminal 3 on a second axial direction X2 side to regulate movement of the male terminal 2 toward the first axial direction X1 in the fitted state in which the male terminal 2 is fitted to the female terminal 3.

The cap 23 is a cap-shaped protective member attached to a distal end side of the male terminal 2, that is, the first axial direction X1 side of the male-side contact portion 20, in order to prevent electric shock. The cap 23 has the same outer diameter as the outer diameter of the male-side contact portion 20 or an outer diameter relatively smaller than the outer diameter of the male-side contact portion 20.

The female terminal 3 includes a female-side contact portion 10, an electric wire connection portion 11, and a coupling portion 12. In the female terminal 3, the female-side contact portion 10, the electric wire connection portion 11, and the coupling portion 12 are integrally formed of a conductive metal material, for example, copper, a copper alloy, aluminum, an aluminum alloy, or the like. In the female terminal 3, each portion is three-dimensionally integrally formed by pressing and bending one sheet metal punched into a shape corresponding to each of the female-side contact portion 10, the electric wire connection portion 11, and the coupling portion 12. In the female terminal 3, the female-side contact portion 10, the coupling portion 12, and the electric wire connection portion 11 are arranged in this order from the second axial direction X2 toward the first axial direction X1 along the axial direction X and are coupled to each other.

The female-side contact portion 10 is a portion where an inner circumferential surface 10a of the female-side contact portion 10 comes into contact with and is electrically connected to the male terminal 2, which is a mating terminal, in the fitted state where the male terminal 2 is fitted to the female terminal 3. The female-side contact portion 10 is formed in a cylindrical shape in which the central axis O is along the axial direction X. The female-side contact portion 10 according to the present embodiment has a slit 13, an insertion space 14, and a base portion 15.

The slit 13 is a gap penetrating from an end portion of the female-side contact portion 10 in the second axial direction X2 to an end portion of the female-side contact portion 10 in the first axial direction X1 and formed linearly in the axial direction X. As illustrated in FIG. 2, when the female-side contact portion 10 is viewed from the axial direction X, the slit 13 is opened in one of the axial direction X and the height direction Z orthogonal to the width direction Y, and allows communication between the outside and the insertion space 14. A size of the slit 13 is relatively smaller than an inner diameter R1/2 of the female-side contact portion 10.

The insertion space 14 is a portion of the female-side contact portion 10 into which a part of the male terminal 2 is inserted. The female-side contact portion 10 is electrically connected to the male terminal 2 by inserting a part of the male terminal 2 into the insertion space 14. A second axial direction X2 side of the female-side contact portion 10 is opened to form an insertion port for the male terminal 2, the insertion port allowing communication between the insertion space 14 and the outside, and the electric wire connection portion 11 is coupled on a first axial direction X1 side of the female-side contact portion 10 via the coupling portion 12.

The base portion 15 is a portion located at a position facing the slit 13 across the insertion space 14 in the female-side contact portion 10. When the male-side contact portion 20 of the male terminal 2 described below is inserted into the insertion space 14, the female-side contact portion 10 is elastically deformed and bent outward in a radial direction (in an arrow direction illustrated in FIG. 2) with the base portion 15 as a bending starting point.

Here, the female-side contact portion 10 and the male-side contact portion 20 according to the present embodiment are formed in such a way that the inner diameter R1 of the female-side contact portion 10<the outer diameter R2 of the male-side contact portion. As illustrated in FIG. 2, the inner diameter R1 is an inner diameter of the inner circumferential surface 10a of the female-side contact portion 10. The outer diameter R2 is an outer diameter of the outer circumferential surface 20a of the male-side contact portion 20.

The electric wire connection portion 11 is a portion to which a core wire or the like of an electric wire (not illustrated) is crimped and which is electrically connected to the electric wire. The electric wire connection portion 11 is implemented by, for example, a pair of barrel pieces and the like.

The coupling portion 12 is a portion that is interposed between the female-side contact portion 10 and the electric wire connection portion 11 and couples the female-side contact portion 10 and the electric wire connection portion 11.

As described above, the connection terminal 1 according to the first embodiment includes the male terminal 2 including the male-side contact portion 20 formed in a cylindrical shape, and the female terminal 3 including the female-side contact portion 10 formed in a cylindrical shape and having the linear slit 13 formed in the axial direction X. The female terminal 3 has the insertion space 14 into which the male-side contact portion 20 is inserted, and the base portion 15 at a position facing the slit 13 across the insertion space 14. In an insertion state in which the male-side contact portion 20 is inserted into the insertion space 14, the female-side contact portion 10 is bent outward in the radial direction with the base portion 15 as the bending starting point and applies a contact load to the male-side contact portion 20.

With the above configuration, the connection terminal 1 can ensure a high contact load corresponding to conduction of a significant current, the contact load being applied by the female-side contact portion 10 to the male-side contact portion 20. As a result, the connection terminal 1 can reduce the number of components without providing a separate spring contact member provided in a female terminal according to the related art. In addition, the connection terminal 1 can reduce component assembly workload as compared with a connection terminal having a two-component structure according to the related art. In addition, since the connection terminal 1 has no contact resistance between components and has a low conductor resistance of a material as compared with the connection terminal having the two-component structure according to the related art, a terminal resistance can be reduced. In addition, the connection terminal 1 can reduce the size of the female terminal 3 as compared with the connection terminal having the two-component structure according to the related art.

In the connection terminal 1 according to the first embodiment, the female-side contact portion 10 and the male-side contact portion 20 are formed in such a way that the inner diameter R1 of the female-side contact portion 10<the outer diameter R2 of the male-side contact portion. As a result, in the connection terminal 1, the female-side contact portion 10 can be bent outward in the radial direction with the base portion 15 as the bending starting point and apply a contact load to the male-side contact portion 20 in the fitted state in which the male terminal 2 is fitted to the female terminal 3.

### Second Embodiment

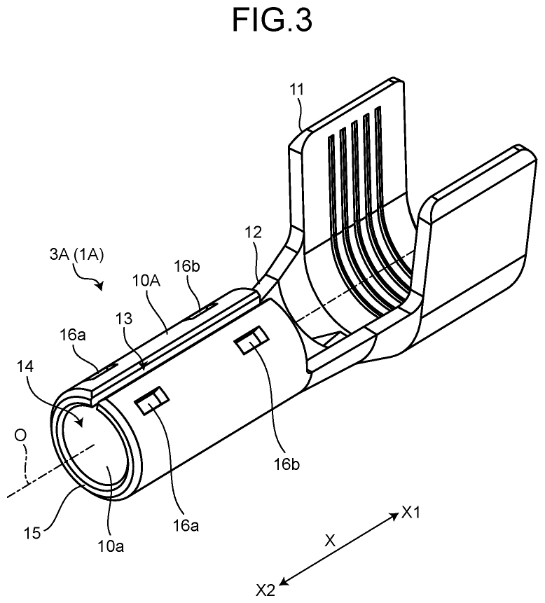

Next, a connection terminal 1A according to a second embodiment will be described with reference to FIGS. 3 to 6. The connection terminal 1A according to the second embodiment is different from the connection terminal 1 according to the first embodiment in that a female terminal 3A includes a pair of indent portions 16a and 16a and a pair of indent portions 16b and 16b. In the second embodiment, the same constituent elements as those in the first embodiment are denoted by the same reference signs, and a detailed description thereof will be omitted.

As illustrated in the drawings, the female terminal 3A includes the pair of indent portions 16a and 16a and the pair of indent portions 16b and 16b protruding inward in a radial direction from both end portions having a slit 13 interposed therebetween in a circumferential direction.

The pair of indent portions 16a and 16a is provided on a second axial direction X2 side of a female-side contact portion 10A. The pair of indent portions 16b and 16b is provided on a first axial direction X1 side of the female-side contact portion 10A. The four indent portions 16a, 16a, 16b, and 16b have the same shape. Each of the indent portions 16a, 16a, 16b, and 16b extends in an axial direction X and has inclined surfaces P at both ends in the axial direction X, the inclined surfaces P being inclined from a radially inner side to a radially outer side in the axial direction X. Each of the indent portions 16a, 16a, 16b, and 16b is provided at a position separated from a base portion 15 in a height direction Z.

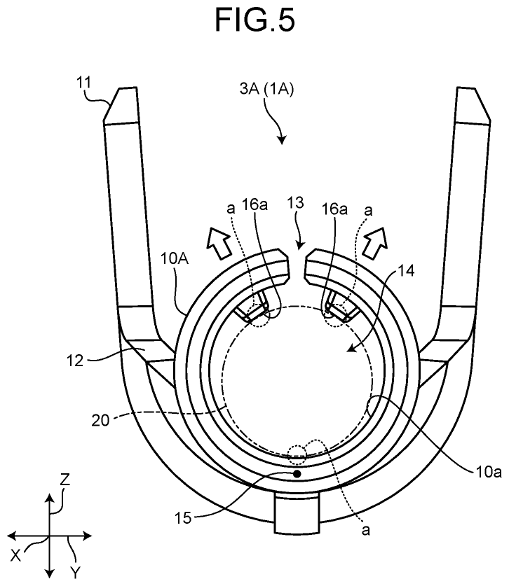

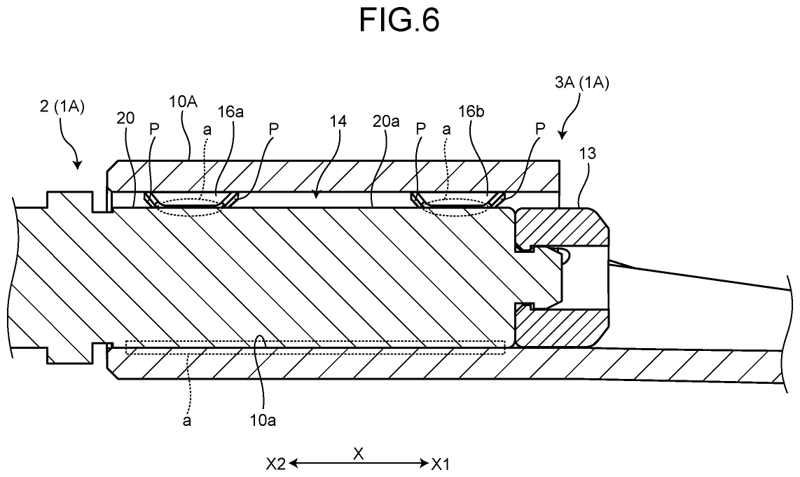

In the female terminal 3A, in a fitted state in which a male terminal 2 is fitted to the female terminal 3A, a distal end of the radially inner side of each of the indent portions 16a, 16a, 16b, and 16b abuts on an outer circumferential surface 20a of a male-side contact portion 20 from one side in the height direction Z, and a portion of an inner circumferential surface 10a that is adjacent to the base portion 15 abuts on the outer circumferential surface 20a from the other side in the height direction Z. In the fitted state in which the male terminal 2 is fitted to the female terminal 3A, when the fitted portion is viewed from the axial direction X as illustrated in FIG. 5, the female-side contact portion 10A of the female terminal 3A supports the male-side contact portion 20 at three points each indicated by a point a. In the fitted state in which the male terminal 2 is fitted to the female terminal 3A, when a cross section of the fitted portion is viewed from the width direction Y as illustrated in FIG. 6, the female-side contact portion 10A of the female terminal 3A supports the male-side contact portion 20 at three points each indicated by the point a.

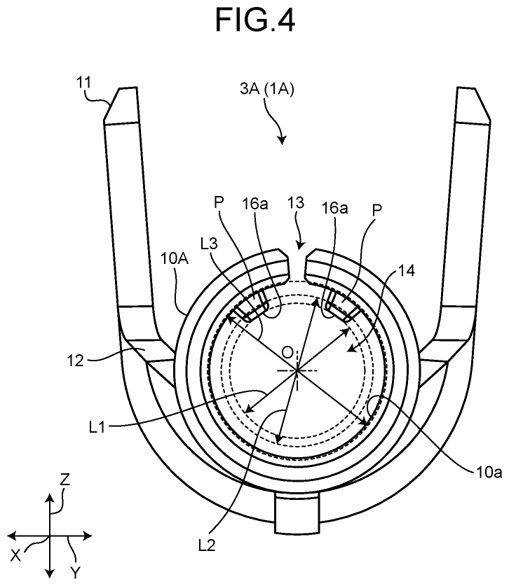

As illustrated in FIG. 4, the pair of indent portions 16a and 16a, the pair of indent portions 16b and 16b, the male-side contact portion 20, and the female-side contact portion 10A are formed in such a way that an inner diameter L1 of each of the indent portions 16a and 16b<an outer diameter L2 of the male-side contact portion 20<an inner diameter L3 of the female-side contact portion.

As described above, in the connection terminal 1A according to the second embodiment, the female-side contact portion 10A includes the pair of indent portions 16a and 16a and the pair of indent portions 16b and 16b protruding inward in the radial direction from both end portions having the slit 13 interposed therebetween in the circumferential direction. Therefore, in the connection terminal 1A, the indent portions 16a and 16b are provided at positions away from the base portion 15, so that the female terminal 3A can hold the male terminal 2 by a moment effect. In addition, in the connection terminal 1A, the female-side contact portion 10A is provided with the pair of indent portions 16a and 16a and the pair of indent portions 16b and 16b spaced apart from each other in the axial direction X, and thus, it is possible to prevent inclination of the male terminal 2 in the axial direction X in the fitted state and to easily achieve line contact between the female-side contact portion 10A and the male-side contact portion 20. As a result, in the connection terminal 1A, a contact area between the female-side contact portion 10A and the male-side contact portion 20 can be increased, and stable connection can be implemented even in a state where a contact resistance is low. In addition, each of the indent portions 16a, 16a, 16b, and 16b has the inclined surfaces P at both ends in the axial direction X, and thus, it is possible to improve assemblability of the male terminal 2 with respect to the female terminal 3A.

In the connection terminal 1A, the indent portions 16a and 16b, the male-side contact portion 20, and the female-side contact portion 10A are formed in such a way that the inner diameter L1 of the indent portions 16a and 16b<the outer diameter L2 of the male-side contact portion 20<the inner diameter L3 of the female-side contact portion. As a result, in the connection terminal 1A, the male terminal 2 can be inserted into the female terminal 3A, and the female-side contact portion 10 can be bent outward in the radial direction with the base portion 15 as a bending starting point and apply a contact load to the male-side contact portion 20 in the fitted state in which the male terminal 2 is fitted to the female terminal 3.

In the second embodiment, the indent portions 16a and the indent portions 16b are divided in the axial direction X, but may be integrally formed and extend in the axial direction X.

### Third Embodiment

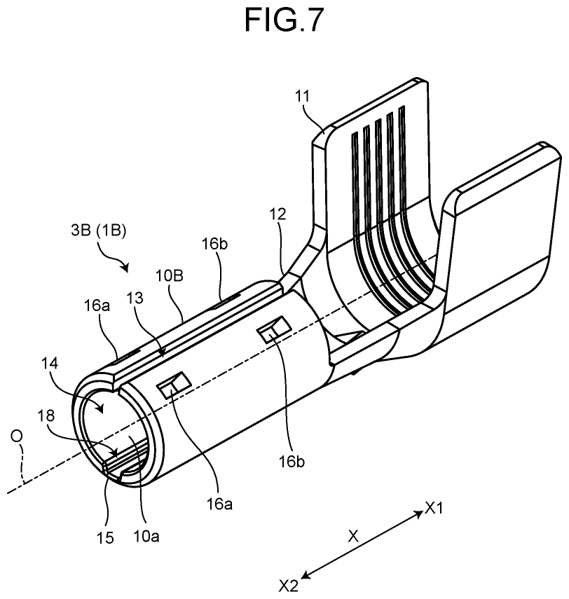

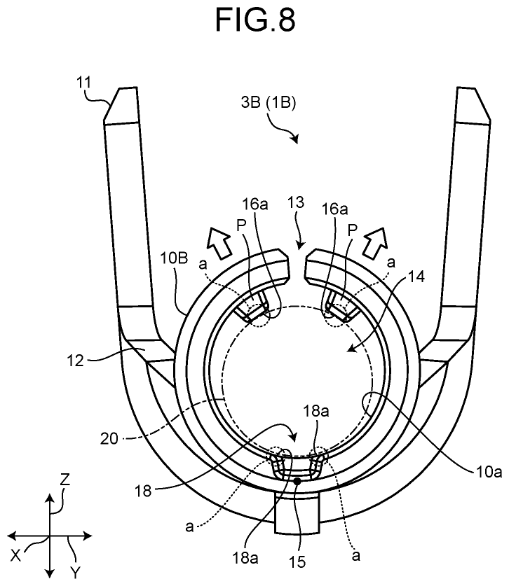

Next, a connection terminal 1B according to a third embodiment will be described with reference to FIGS. 7 and 8. The connection terminal 1B according to the third embodiment is different from the connection terminal 1A according to the second embodiment in that a female terminal 3B has a groove-shaped portion 18. In the third embodiment, the same constituent elements as those in the first and second embodiments are denoted by the same reference signs, and a detailed description thereof will be omitted.

A female-side contact portion 10B has a groove-shaped portion 18 formed in a base portion 15 and recessed outward in a radial direction from an inner circumferential surface 10a of the female-side contact portion 10B. The groove-shaped portion 18 is formed to linearly extend in an axial direction X, and is provided at a position facing a slit 13 in a height direction Z. The groove-shaped portion 18 is formed to have a substantially rectangular cross-sectional shape when viewed from the axial direction X. The groove-shaped portion 18 is formed by, for example, reducing a thickness of the base portion 15 from a radially inner side.

In the female terminal 3B, in a fitted state in which a male terminal 2 is fitted to the female terminal 3B, a distal end of a radially inner side of each of indent portions 16a, 16a, 16b, and 16b abuts on an outer circumferential surface 20a of a male-side contact portion 20 from one side in the height direction Z, and corner portions 18a at both ends of the groove-shaped portion 18 in a circumferential direction abut on the outer circumferential surface 20a from the other side in the height direction Z. In the fitted state in which the male terminal 2 is fitted to the female terminal 3B, when the fitted portion is viewed from the axial direction X as illustrated in FIG. 8, the female-side contact portion 10B of the female terminal 3B supports the male-side contact portion 20 at four points each indicated by a point a.

As described above, the connection terminal 1B according to the third embodiment has the groove-shaped portion 18 which is formed by reducing the thickness of the base portion 15 and is recessed outward in the radial direction from the inner circumferential surface 10a of the female-side contact portion 10B. Therefore, in the connection terminal 1B, even in a case where a thickness of the female-side contact portion 10B in a radial direction is relatively large and the female-side contact portion 10B is hardly elastically deformed in the fitted state, the base portion 15 is thinned by the formation of the groove-shaped portion 18. As a result, in the connection terminal 1B, the female-side contact portion 10B can be easily bent with the base portion 15 as a bending starting point, and a contact load applied by the female-side contact portion 10B to the male-side contact portion 20 and an insertion force of the male terminal 2 with respect to the female terminal 3B can be adjusted by adjusting a depth (thickness reduction amount) of the groove-shaped portion 18.

In the connection terminal 1B, when a distal end of the male terminal 2 on a first axial direction X1 side is inserted into an insertion space 14 of the female terminal 3B, the male terminal 2 is guided toward the first axial direction X1 while a part of the distal end slides on the pair of corner portions 18a of the groove-shaped portion 18. Thus, the connection terminal 1B facilitates work of inserting the male terminal 2 into the female terminal 3B. In addition, in the connection terminal 1B, as the pair of indent portions 16a and 16a and the pair of indent portions 16b and 16b are provided while being spaced apart from each other in the axial direction X, it is easy to achieve line contact in the axial direction X between the two corner portions 18a of the groove-shaped portion 18 and the outer circumferential surface 20a of the male-side contact portion 20, so that stable electrical contact can be achieved.

### Modified Example of Third Embodiment

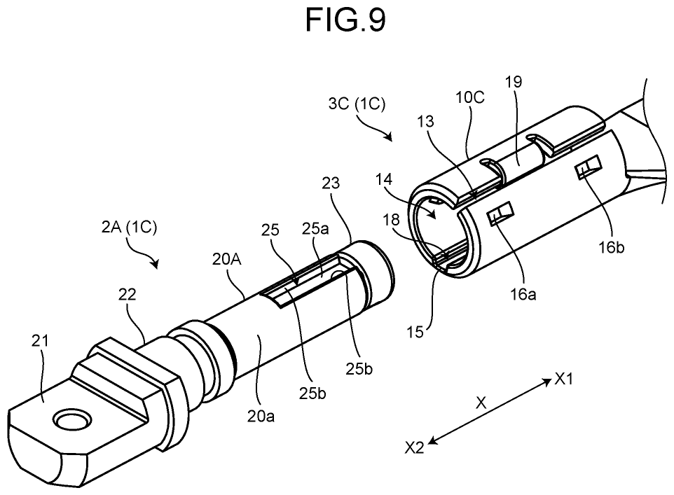

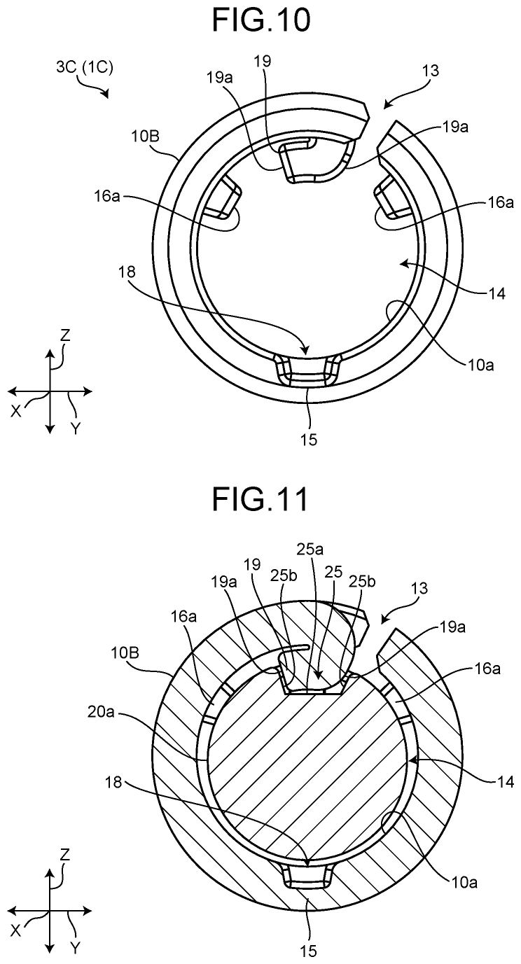

Next, a connection terminal 1C according to a modified example of the third embodiment will be described with reference to FIGS. 9 to 11. The connection terminal 1C according to the modified example of the third embodiment is different from the connection terminal 1B according to the third embodiment in that a female terminal 3C has a protrusion 19, and a male terminal 2A has a recess 25 corresponding to the protrusion 19.

The protrusion 19 is a portion protruding inward in a radial direction from an inner circumferential surface 10a of a female-side contact portion 10C. The protrusion 19 is formed to protrude from one of both end portions having a slit 13 interposed therebetween in a circumferential direction toward an insertion space 14. The illustrated protrusion 19 is formed in such a way that the one of both end portions having the slit 13 interposed therebetween in the circumferential direction is folded back in the circumferential direction, but is not limited thereto. The protrusion 19 is disposed in a region between an indent portion 16a provided on a second axial direction X2 side and an indent portion 16b provided on a first axial direction X1 side on the inner circumferential surface 10a of the female-side contact portion 10C.

The recess 25 is formed in such a way as to be recessed inward in the radial direction from an outer circumferential surface 20a of a male-side contact portion 20A. The recess 25 extends from an end portion of the male-side contact portion 20A on a first axial direction X1 side toward the second axial direction X2. An opening is formed on a first axial direction X1 side of the recess 25, and the opening is closed by mounting a cap 23 on the male-side contact portion 20A. The recess 25 has a substantially rectangular cross-sectional shape when viewed from the axial direction X. The recess 25 has a bottom surface 25a positioned on a radially inner side and a pair of facing surfaces 25b facing each other in the circumferential direction with the bottom surface 25a interposed therebetween. The protrusion 19 is inserted into the recess 25 in a fitted state in which the male terminal 2A is fitted to the female terminal 3C.

In the connection terminal 1C, the protrusion 19 is inserted into the recess 25 in the fitted state in which the male terminal 2A is fitted to the female terminal 3C. In this case, in the connection terminal 1C, when the male terminal 2A tries to rotate to one side in the circumferential direction with respect to the female terminal 3C, the protrusion 19 abuts on one of the facing surfaces 25b, and the rotation of the male terminal 2A is regulated. On the other hand, in the connection terminal 1C, when the male terminal 2A tries to rotate to the other side in the circumferential direction with respect to the female terminal 3C, the protrusion 19 abuts on the other of the facing surfaces 25b, and the rotation of the male terminal 2A is regulated. As a result, the connection terminal 1C can regulate the rotation of the male terminal 2A in the circumferential direction in the fitted state, thereby improving an ability of the female terminal 3C to hold the male terminal 2A, and stabilizing electrical contact between the male terminal 2A and the female terminal 3C.

With the connection terminal according to the present embodiments, it is possible to reduce the number of components.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connection terminal comprising:
a male terminal including a male-side contact portion formed in a cylindrical shape; and
a female terminal including a female-side contact portion formed in a cylindrical shape and having a linear slit formed in an axial direction, wherein
the female terminal has an insertion space formed inside the female-side contact portion and into which the male-side contact portion is inserted, and a base portion located at a position facing the slit across the insertion space, and
the female-side contact portion is bent outward in a radial direction intersecting the axial direction with the base portion as a bending starting point and applies a contact load to the male-side contact portion in an insertion state in which the male-side contact portion is inserted into the insertion space.

2. The connection terminal according to claim 1, wherein
the female-side contact portion and the male-side contact portion are formed in such a way that an inner diameter of the female-side contact portion<an outer diameter of the male-side contact portion.

3. The connection terminal according to claim 1, wherein
the female-side contact portion includes a pair of indent portions protruding inward in the radial direction from both end portions having the slit interposed therebetween in a circumferential direction, and
the indent portion, the male-side contact portion, and the female-side contact portion are formed in such a way that an inner diameter of the indent portion<an outer diameter of the male-side contact portion<an inner diameter of the female-side contact portion.

4. The connection terminal according to claim 3, wherein
the female-side contact portion has a groove-shaped portion formed in the base portion and recessed outward in the radial direction from an inner circumferential surface of the female-side contact portion.

5. The connection terminal according to claim 1, wherein
the female terminal has a protrusion protruding inward in the radial direction from an inner circumferential surface of the female-side contact portion,
the male terminal has a recess which is recessed inward in the radial direction from an outer circumferential surface of the male-side contact portion and into which the protrusion is inserted in the insertion state, and
the recess has a pair of facing surfaces facing each other in a circumferential direction with the protrusion interposed therebetween.
